(19) United States
(12) Patent Application Publication
(10) Pub. No.: US 2026/0099671 A1
(43) Pub. Date: Apr. 9, 2026

(54) SYSTEM AND METHOD FOR AUTHORING, VALIDATING, AND INDEXING INBOUND AND OUTBOUND DOCUMENTS

(71) Applicant: BANK OF AMERICA CORPORATION, Charlotte, NC (US)

(72) Inventors: Sharad Kalyani, Coppell, TX (US); Aftab Khan, Richardson, TX (US); Saurabh Khanna, Frisco, TX (US); Pawan K. Shetty, McKinney, TX (US); Mansoor Zafar, Frisco, TX (US)

(73) Assignee: BANK OF AMERICA CORPORATION, Charlotte, NC (US)

(21) Appl. No.: 18/905,888

(22) Filed: Oct. 3, 2024

(51) Int. Cl. G06F 40/226; G06F 16/31; G06F 16/35; G06F 16/383

(52) U.S. Cl. CPC G06F 40/226; G06F 16/31; G06F 16/35; G06F 16/383

(57) ABSTRACT

Systems, computer program products, and methods are described herein for authoring, validating, and indexing inbound and outbound documents. The invention utilizes a fine-tuned Large Language Model (LLM) for authoring, validation, and indexing of both outbound and inbound correspondence within regulated entities. This system is designed to enhance efficiency and compliance by addressing three key areas: document authoring, content validation, and document indexing. For outbound document distribution and final artifact generation, the system incorporates a content authoring co-pilot that employs a prompt-based content generation, tagging, and content translation, while a content validator checks for static content, fonts, styles, logos, and images. For inbound document receiving, the system automates classification, data extraction, and document comparison. This optimization supports a unified approach to handling both outgoing and incoming documents, reducing manual effort and ensuring consistency in document processing across diverse channels.

### BACKGROUND

Entities in specific sectors have mandatory or regulated inbound and outbound document distribution requirements. Depending on the entity field, many of these documents have taxonomy regulations either internally or externally. Currently both the outbound distribution of documents and incoming receivable documents are handled manually with respect to taxonomy, content, and indexing. Even the automation portions of the process of inbound and outbound document management requires a significant effort to create and maintain. As such, a need exists for a system and method for authoring, validation, and indexing inbound and outbound documents.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

The disclosed system, method, and computer program product utilizes a fine-tuned Large Language Model (LLM) for authoring, validation, and indexing of both outbound and inbound correspondence within regulated entities. This system is designed to enhance efficiency and compliance by addressing three key areas: document authoring, content validation, and document indexing.

For outbound document distribution and final artifact generation, the system incorporates a content authoring co-pilot that employs a prompt-based content generation, tagging, and content translation, while a content validator checks for static content, fonts, styles, logos, and images.

For inbound document receiving, the system automates classification, data extraction, and document comparison. The LLM is fine-tuned using techniques such as supervised fine-tuning, retrieval augmented generation, and prompt engineering, enabling it to recognize domain-specific templates and terminologies used by the entity or like entities. This optimization supports a unified approach to handling both outgoing and incoming documents, reducing manual effort and ensuring consistency in document processing across diverse channels.

The present invention includes systems, methods, and computer program products for authoring, validating, and indexing inbound and outbound documents, the invention comprising: slicing data packets associated with previously delivered and previously received documents, wherein the sliced data packets are inputted into a large language model (LLM); authoring, based on an identification of taxonomy, an artifact for outbound distribution; performing validation of the authored artifact for outbound distribution, wherein the validation comprises static content validation, format validation, and data validation; indexing inbound documents by processing the inbound document via the LLM for taxonomy identification and linking of inbound document to individual account; and feeding the LLM with slice data packets of inbound documents for a feedback loop of LLM.

In some embodiments, indexing inbound documents further comprises scanning the inbound documents by the LLM to identify a formatting of the inbound documents, static content of the inbound document, and data of the inbound document and tagging the inbound document to an account associated with the data of the inbound document.

In some embodiments, the taxonomy of an artifact further comprises a formatting of the artifact, a static content of the artifact, and data of the artifact. In some embodiments, the formatting of the artifact comprises a font and format of a document, wherein the static content of the artifact comprises compliance with regulatory and entity guidelines associated with a type of document, and wherein the data of the artifact comprises individual data associated with an addressee of a document.

In some embodiments, authoring the artifact for outbound distribution further comprises providing a co-pilot module for displaying of data in one or more template artifact taxonomy.

In some embodiments, the slice data packets comprise data identifying the taxonomy of the previously delivered and previously received documents and train the LLM via supervised fine-tuning, retrieval augmented generation, and prompt engineering of the splice data packets.

In some embodiments, the authored artifact is a document that is physically mailed to an individual with information about an account, product, service, or status the individual has affiliated with an entity.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for authoring, validating, and indexing inbound and outbound documents, in accordance with an embodiment of the invention;

FIG. 2 illustrates a process flow for authoring, validating, and indexing inbound and outbound documents in accordance with an embodiment of the invention; and

FIG. 3 illustrates a process flow for authoring, validating, and indexing inbound and outbound documents in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. The entity may also generate, distribution, and receive communications from outside individuals, businesses, customers, or the like. These communications may be in the form of documents such as statements, letters, requests, approvals, rejections, or the like. The entity and/or third party agencies may regulate portions of the taxonomy of the documents. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, a “document” may encompass a letter, statement, request, rejection, acceptance, or the like in a physical format. The document may be directly connect to an account, resources, or association an individual has with an entity. An inbound document may be one sent from an individual or entity to the entity. An outbound document may be one sent from the entity to an individual or entity with an account or associated to the entity. A generated document may be an artifact.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

The disclosed invention provides a system for authoring, validating, and indexing inbound and outbound documents, which utilizes a fine-tuned large language model (LLM) to improve the efficiency, accuracy, and compliance of document management in regulated industries. The system integrates artificial intelligence and machine learning technologies to automate various aspects of the document lifecycle, reducing manual intervention, and ensuring consistency across different types of documents.

In some embodiments, the system slices data packets associated with previously delivered and received documents. These data packets are inputted into the LLM, which uses the data to identify document taxonomy and support various document processing operations. The slicing of data packets enables the LLM to be trained and fine-tuned with techniques such as supervised fine-tuning, retrieval augmented generation, and prompt engineering. This training allows the LLM to understand the taxonomy of the documents and generate context-aware content based on predefined templates.

In some embodiments, the invention authors outbound documents or artifacts, based on the identification of the document's taxonomy. The taxonomy may include document formatting, static content, and data. The authored artifact undergoes validation through multiple layers: static content validation, format validation, and data validation. This ensures that the authored content is compliant with regulatory requirements and aligned with entity-specific guidelines before being distributed. Furthermore, LLM-supported co-pilot module displays data within one or more template artifact taxonomies, allowing users to customize content as needed while maintaining consistency with the entity's style and compliance requirements.

For inbound document processing, the system utilizes the LLM to perform document indexing. This involves scanning the inbound documents to identify formatting, static content, and data elements, followed by tagging and linking the document to the appropriate account within the entity's database. The indexed data can be used to further fine-tune the LLM, creating a feedback loop that enhances the model's performance and accuracy over time. The system thus creates an integrated and unified approach to handling both outbound and inbound documents through a single LLM that is continuously trained and updated using real-world document data.

The described system, method, and computer program product provide a practical application of a technical solution to a specific problem in the field of document management and processing. The disclosed invention improves the functioning of computer systems by expediting the authoring, validation, and indexing of documents using advanced machine learning techniques. The system performs specific functions such as slicing data packets, validating content, and indexing documents, which require specialized data processing capabilities that go beyond the mere implementation of abstract ideas on a generic computer system. By leveraging a fine-tuned LLM, the invention reduces the processing effort needed to create and validate documents, thereby providing a significant technical improvement in the handling of inbound and outbound documents in regulated environments. In this way, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

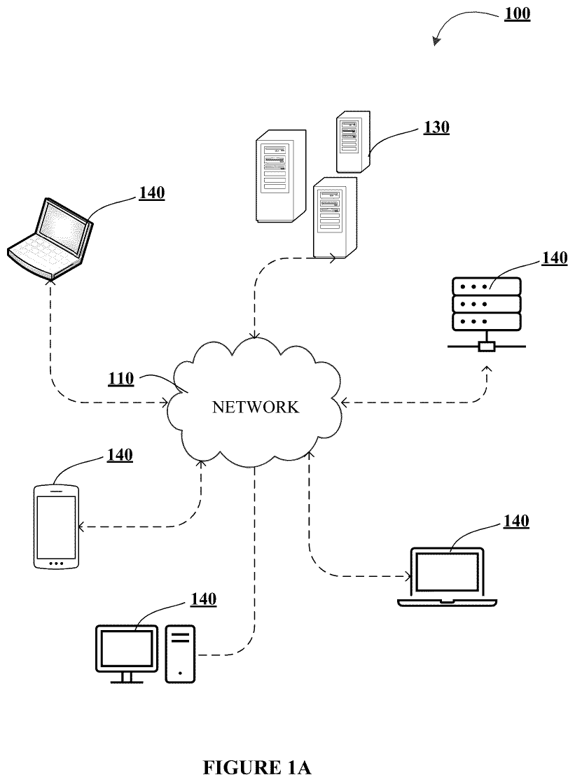

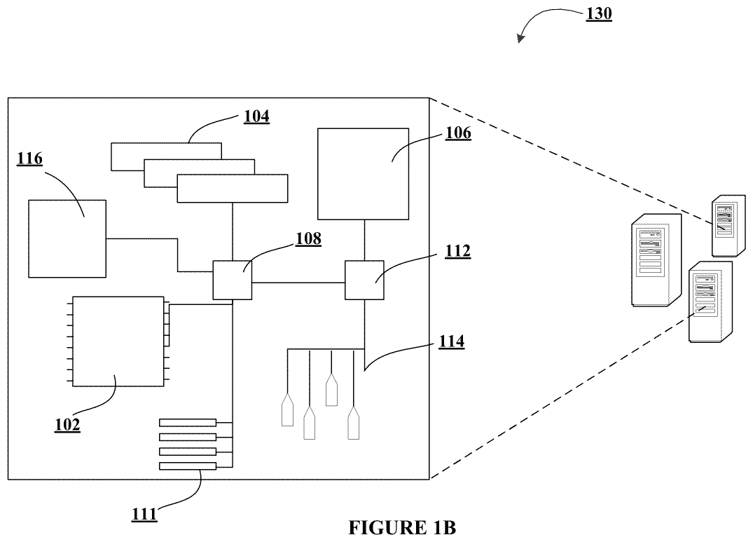

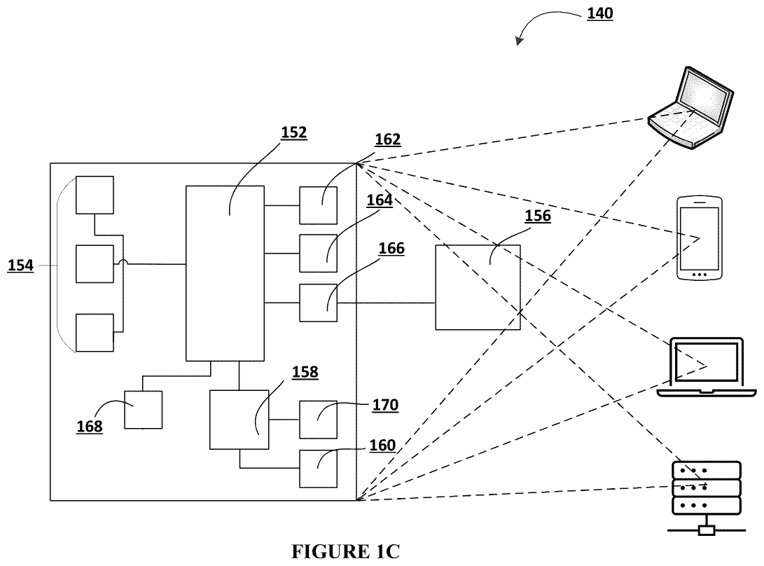

FIGS. 1A-1C illustrate technical components of an exemplary distributed computing environment for authoring, validation, and indexing inbound and outbound documents 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it. The end-point device(s) 140 may associated with the entity and associated with the authoring, validation, and indexing inbound and outbound documents. The end-point device(s) 140 are authorized access to one or more of the authoring, validating, and/or indexing frameworks.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other. The system 130 may have specific hardware and code to fine tune an open source LLM and augment the LLM by a combination of techniques like supervised fine tuning, retrieval augmented generation, and prompt engineering. A single optimized LLM will support users in content authoring (co-pilot) and then in the content validation to reduce the effort and time it takes to create new content for outgoing correspondence.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

The present invention relates to a system, method and computer program product for authoring, validating, and indexing incoming and outgoing documents or artifacts through the use of advanced machine learning models, such as LLMs. The process efficiently handles document requests, enriches responses, fine-tunes models, and processes documents through various channels.

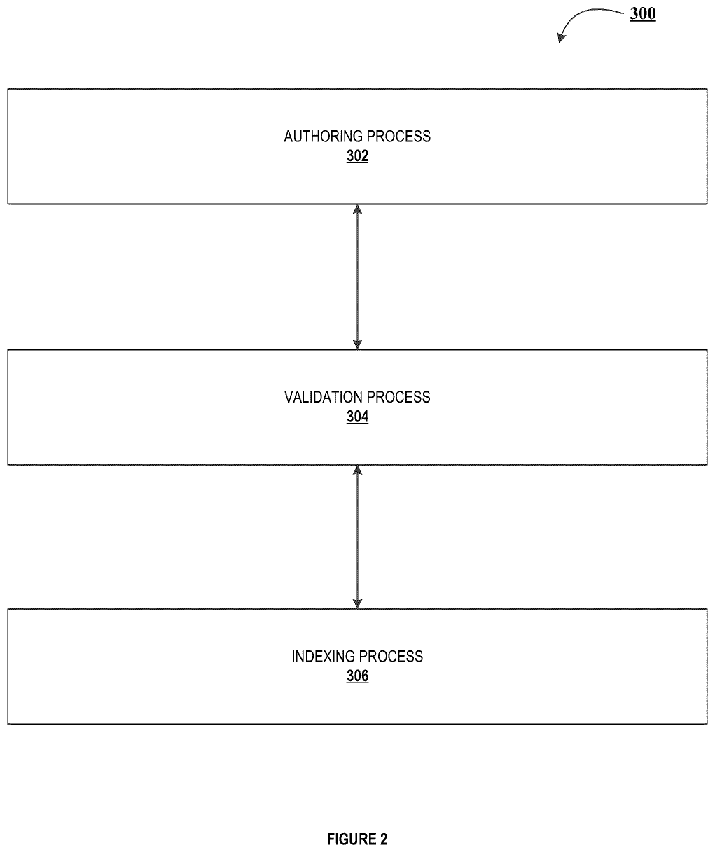

FIG. 2 illustrates a process flow for authoring, validating, and indexing inbound and outbound documents 300, in accordance with an embodiment of the invention. As illustrated in block 302, the process is initiated with the authoring process. When documents need to be distributed from an entity to an individual, there are many factors to consider. Each line of business within the entity may have different requirements for the taxonomy of the document, the taxonomy may include the static content, the formatting, and the data associated with each document. In some embodiments, the static content may include the information required in the document for regulatory compliance, entity internal compliance, or the like. In some embodiments, the formatting may include guidelines within entity for logos, fonts, colors, indenting, bar code locations, and the like. Finally, in some embodiments, the data requirement may include account numbers or specific data associated with the individual addressee of the document.

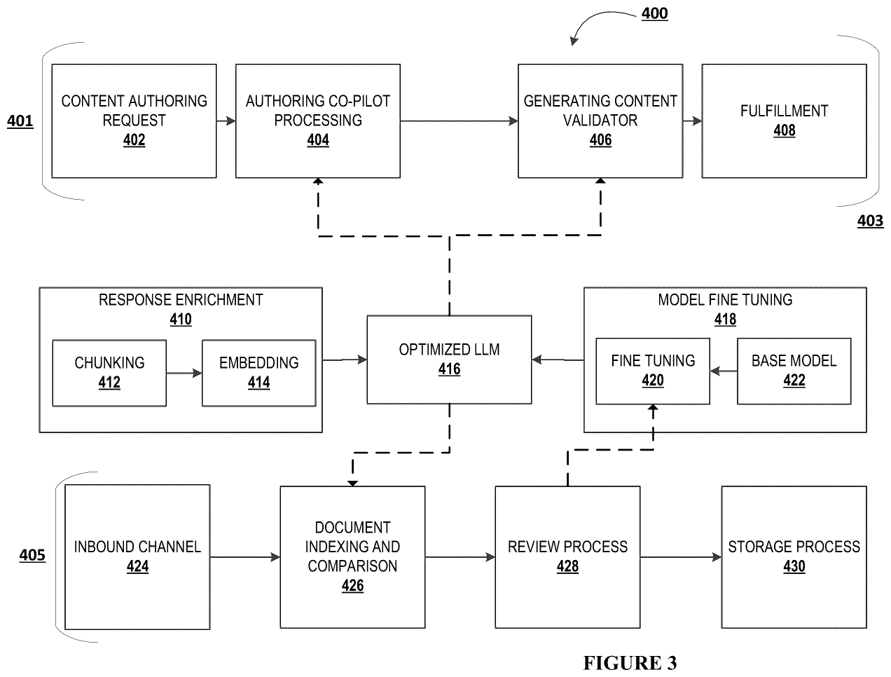

FIG. 3 illustrates a process flow for authoring, validating, and indexing inbound and outbound documents 400, in accordance with an embodiment of the invention. Initially, the system extracts data from historical final artifact generated and cuts data into segmented data strands. These strands are used to train the LLM for utilization as a pilot for authoring of the artifact. Furthermore, the LLM is trained on the different line of business content requirements, regulatory compliance, formatting, static content, and data input. The authoring process is illustrated in block 401. The process is initiated with a content authorizing request 402. This is the initial step where a user or user device initiates a request for artifact generation. The authoring request can be based on various parameters associated with the entity, such as required documents for account maintenance, approval correspondence, statements, requests for information, or the like affiliated with the entity and the entity products.

In some embodiments, the content authorizing request may be prompt based content injection with content translation. Based on the prompt provided by a user, the system identifies the taxonomy of the artifact to be generated, including the information needed and the content requirement, to generate an artifact tailored to the taxonomy by using the LLM.

Following the content request, the process continues to the authoring co-pilot process, as illustrated in block 404. The authoring co-pilot component is responsible for managing the content generation of the artifact. This component may include interactive features that help guide the authoring process or integrate with additional tools to refine the input before proceeding to content validation. The authoring co-pilot process is limed to the LLM 416 for generation of the appropriate taxonomy of the artifact. In some embodiments, the authoring co-pilot further displays information on a user device within one or more template artifact taxonomies. The co-pilot guides the user in selecting and arranging the content based on pre-defined document structures, regulatory requirements, and static content, format, data, and other contextual details. This feature provides real-time assistance and streamlines the authoring phase.

FIG. 2 illustrates a process flow for authoring, validating, and indexing inbound and outbound documents 300, in accordance with an embodiment of the invention. As illustrated in block 304, the process continues with the validation process. At this point, the authoring has generated a concept for the artifact, now it being validated prior to distribution. There are three parts validate formatting/taxonomy. First, the system performs static content validation, this includes validating compliance with guidelines and regulations both entity and external. Ensure that content is accurate and in line with regulatory guidelines. Second, the system performs format validation confirming that the artifact is in compliance with any guideline within entity on colors, logos, fonts, indenting, bar code locations, and the like. Finally, the system performs data validation by accessing other servers within an entity to gain access to the data. The data is ingested from the individual server locations and integrated into the artifact for completion. The data and server is then linked to the artifact for future indexing. Finally, a user can sample different letter taxonomy and confirm artifact has correct data.

Referring back to FIG. 3, as illustrated in block 406, the process continues to the generating content validator for validation of the content. The validation is shown in process 403. In this way, the content now moves to the composition and fulfillment states. The generating content validator analyzes and validates the content generated in the previous step. The content validator checks for static content, font and system, and image validation. In some embodiments, the content validator further checks for criteria such as grammatical correctness, adherence to style guidelines, and semantic coherence, ensuring the content meets predefined quality standards. Upon successful validation, the process continues to block 408 for fulfillment. In some embodiments, fulfillment comprises the physical generation of the artifact into final form, such as a document, an electronic correspondence, or the like and is transmitted to the addressee.

Block 416 illustrates the optimized LLM for the authoring, validating, and indexing the inboard and outboard documents. Inputting into the optimized LLM 416 includes response enrichment 410. Response enrichment 410, aids in augmenting the LLM with a combination of techniques like supervised fine tuning, retrieval augmented generation, and prompt engineering. In some embodiments, the response enrichment 410 uses the retrieval augmented generation approach. The response enrichment process 410 involves two key sub-components, chunking 412 and embedding 414. Chunking 412 breaks the input data into manageable segments or chunks, which facilitates better content handling and processing. Embedding 414 is the process of converting these chunks into a vectorized format that the machine learning model can easily understand and process.

The system further enhances the LLM via model fine tuning 418. The fine-tuning process takes place in two steps. Initially, a base model 422 is utilized, which is a pre-trained language model with generalized knowledge across various domains. Then, the base model undergoes a fine tuning 420 process, where the model is adjusted based on specific datasets and user feedback to optimize it for specialized tasks. This fine tuned model is incorporated back into the system for further use in content generation.

The enriched content from the response enrichment 410 and the model fine tuning 418 is imputed into the optimized LLM 416, a large language model that has been trained and optimized to generate high-quality and contextually accurate content. This LLM receives input from both the authoring process and the response enrichment to ensure consistency and quality across all generated outputs. Furthermore, the optimized LLM 416 further comprises a feedback loop for continued learning and document authoring, validation, and index improvement.

Referring back to FIG. 2, FIG. 2 illustrates a process flow for authoring, validating, and indexing inbound and outbound documents 300, in accordance with an embodiment of the invention. As illustrated in block 306, the process continues with the indexing process. The indexing process 306 is the process of receiving incoming documents either physical or digital, reviewing those documents to determine the contents, storing the documents associated with the appropriate account, product, or individual, and performing an action function based on the incoming document. The indexing of these documents from the identification of the sender, storage, and triggering of action item are performed by the LLM.

Referring back to FIG. 3, FIG. 3 illustrates a process flow for authoring, validating, and indexing inbound and outbound documents 400, in accordance with an embodiment of the invention. The indexing process is illustrated in block 405. The indexing process 405 is initiated by receiving a correspondence via an inbound channel, as illustrated in block 424. The inbound channel allows the system to receive documents, files, or inputs from external sources. These may be digital or physical documents. Once received, the documents are scanned then are processed and analyzed by the system via a document indexing and comparison, as illustrated in block 426. Document indexing and comparison indexes the incoming content and compares it against existing databases and the LLM to identify the account, classification, and taxonomy of the received document.

After the content has been indexed and compared, it enters a review process, as illustrated in block 428. The review process 428 may, in some embodiments, include a user review to evaluate the content for additional quality assurance and compliance with specific rules or standards. Following the review process, the content is stored in the storage process, as illustrated in block 430. The system may store the indexed incoming document with an account, product, or the like, where it can be retrieved for future use or referenced for subsequent authoring tasks. In some embodiments, the storage triggers an action or authoring item based on the correspondence received.

The overall system architecture integrates multiple processes and components to efficiently generate, validate, optimize, and store content. It leverages machine learning and large language models to enhance both the quality and consistency of the content generation process, ensuring it meets the needs of various users and applications.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for authoring, validating, and indexing inbound and outbound documents, the system comprising:
at least one non-transitory storage device with computer-readable program code stored thereon; and
at least one processor coupled to the at least one non-transitory storage device, wherein the at least one processor is configured to execute the computer-readable program code to:
slice data packets associated with previously delivered and previously received documents, wherein the sliced data packets are inputted into a large language model (LLM);
author, based on an identification of taxonomy, an artifact for outbound distribution;
perform validation of the authored artifact for outbound distribution, wherein the validation comprises static content validation, format validation, and data validation;
index inbound documents by processing the inbound document via the LLM for taxonomy identification and linking of inbound document to individual account; and
feed the LLM with slice data packets of inbound documents for a feedback loop of LLM.

2. The system of claim 1, wherein indexing inbound documents further comprises scanning the inbound documents by the LLM to identify a formatting of the inbound documents, static content of the inbound document, and data of the inbound document and tagging the inbound document to an account associated with the data of the inbound document.

3. The system of claim 1, wherein the taxonomy of an artifact further comprises a formatting of the artifact, a static content of the artifact, and data of the artifact.

4. The system of claim 3, wherein the formatting of the artifact comprises a font and format of a document, wherein the static content of the artifact comprises compliance with regulatory and entity guidelines associated with a type of document, and wherein the data of the artifact comprises individual data associated with an addressee of a document.

5. The system of claim 1, wherein authoring the artifact for outbound distribution further comprises providing a co-pilot module for displaying of data in one or more template artifact taxonomy.

6. The system of claim 1, wherein the slice data packets comprise data identifying the taxonomy of the previously delivered and previously received documents and train the LLM via supervised fine-tuning, retrieval augmented generation, and prompt engineering of the splice data packets.

7. The system of claim 1, wherein the authored artifact is a document that is physically mailed to an individual with information about an account, product, service, or status the individual has affiliated with an entity.

8. A computer program product for authoring, validating, and indexing inbound and outbound documents, the computer program product comprising a non-transitory computer-readable medium comprising code causing an apparatus to:
slice data packets associated with previously delivered and previously received documents, wherein the sliced data packets are inputted into a large language model (LLM);
author, based on an identification of taxonomy, an artifact for outbound distribution;
perform validation of the authored artifact for outbound distribution, wherein the validation comprises static content validation, format validation, and data validation;
index inbound documents by processing the inbound document via the LLM for taxonomy identification and linking of inbound document to individual account; and
feed the LLM with slice data packets of inbound documents for a feedback loop of LLM.

9. The computer program product of claim 8, wherein indexing inbound documents further comprises scanning the inbound documents by the LLM to identify a formatting of the inbound documents, static content of the inbound document, and data of the inbound document and tagging the inbound document to an account associated with the data of the inbound document.

10. The computer program product of claim 8, wherein the taxonomy of an artifact further comprises a formatting of the artifact, a static content of the artifact, and data of the artifact.

11. The computer program product of claim 10, wherein the formatting of the artifact comprises a font and format of a document, wherein the static content of the artifact comprises compliance with regulatory and entity guidelines associated with a type of document, and wherein the data of the artifact comprises individual data associated with an addressee of a document.

12. The computer program product of claim 8, wherein authoring the artifact for outbound distribution further comprises providing a co-pilot module for displaying of data in one or more template artifact taxonomy.

13. The computer program product of claim 8, wherein the slice data packets comprise data identifying the taxonomy of the previously delivered and previously received documents and train the LLM via supervised fine-tuning, retrieval augmented generation, and prompt engineering of the splice data packets.

14. The computer program product of claim 8, wherein the authored artifact is a document that is physically mailed to an individual with information about an account, product, service, or status the individual has affiliated with an entity.

15. A method for authoring, validating, and indexing inbound and outbound documents, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
slicing data packets associated with previously delivered and previously received documents, wherein the sliced data packets are inputted into a large language model (LLM);
authoring, based on an identification of taxonomy, an artifact for outbound distribution;
performing validation of the authored artifact for outbound distribution, wherein the validation comprises static content validation, format validation, and data validation;
indexing inbound documents by processing the inbound document via the LLM for taxonomy identification and linking of inbound document to individual account; and
feeding the LLM with slice data packets of inbound documents for a feedback loop of LLM.

16. The method of claim 15, wherein indexing inbound documents further comprises scanning the inbound documents by the LLM to identify a formatting of the inbound documents, static content of the inbound document, and data of the inbound document and tagging the inbound document to an account associated with the data of the inbound document.

17. The method of claim 15, wherein the taxonomy of an artifact further comprises a formatting of the artifact, a static content of the artifact, and data of the artifact.

18. The method of claim 17, wherein the formatting of the artifact comprises a font and format of a document, wherein the static content of the artifact comprises compliance with regulatory and entity guidelines associated with a type of document, and wherein the data of the artifact comprises individual data associated with an addressee of a document.

19. The method of claim 15, wherein authoring the artifact for outbound distribution further comprises providing a co-pilot module for displaying of data in one or more template artifact taxonomy.

20. The method of claim 15, wherein the slice data packets comprise data identifying the taxonomy of the previously delivered and previously received documents and train the LLM via supervised fine-tuning, retrieval augmented generation, and prompt engineering of the splice data packets.
